(19) United States
(12) Patent Application Publication
(10) Pub. No.: US 2006/0218415 A1
(43) Pub. Date: Sep. 28, 2006

(54) System and method for powering a peripheral device

(75) Inventors: David Mak-Fan, Waterloo (CA); Dusan Veselic, Oakville (CA); Max Matton, Waterloo (CA)

Correspondence Address: BERESKIN AND PARR, 40 KING STREET WEST, BOX 401, TORONTO, ON, M5H 3Y2, CA

(73) Assignee: Research In Motion Limited, Waterloo (CA)

(21) Appl. No.: 11/086,354

(22) Filed: Mar. 23, 2005

(51) Int. Cl. G06F 1/00

(52) U.S. Cl. 713/300

(57) ABSTRACT

A system for powering a peripheral device with a host device is described. The system includes N host interface power ports, each adapted for coupling to a corresponding host port on the host device to deliver power to the peripheral device. A current adding unit adds current received from the host device via at least the N host interface power ports to produce a total current. A power terminal is coupled to the peripheral device to send the total current from the current adding unit to the peripheral device.

### FIELD OF THE INVENTION

This invention relates to peripheral devices that can be connected to a computer, and more specifically to powering such peripheral devices.

### BACKGROUND OF THE INVENTION

Widespread peripheral devices that can be connected to a computer, such as personal data assistants (PDA), cell phones and printers, are powered by the computer to which they are connected, and/or are self-powered by their own power supply, typically a battery pack. When re-charging is necessary, the peripheral device with the battery pack contained therein, can be powered by a computer to re-charge the battery pack. A convenient method to power a PDA in a mobile setting, for example, involves the use of a laptop computer. If the PDA is running low on batteries in the field, the PDA can be connected to a battery-operated laptop computer for powering. If one power outlet is available, the computer can be plugged into the one outlet and the PDA can be connected to the computer to power the PDA for recharging the batteries and to provide power to the components of the PDA.

To make such a connection between a computer and a peripheral device, it is necessary to have installed in both the computer and the peripheral device appropriate software, known as a device driver, to establish and control the connection. Device drivers can be categorized according to the communication standard to which they adhere.

One category of device drivers adheres to the standard known as universal serial bus, better known by its acronym USB. Device drivers that are USB compliant are convenient because many personal computers (PCs) come with USB ports. USB permits many peripheral device connections at one time. Another convenient USB feature is that it distributes electrical power to many peripherals. USB lets the PC automatically sense the power that is required and deliver it to the device. USB “hot-swapping” obviates the need to shut down and restart the PC to attach or remove a peripheral device: the PC automatically detects the peripheral device and configures the necessary software. This feature is especially useful for users of multi-player games, as well as laptop PC users who want to share peripheral devices.

As convenient as USB is, however, one major drawback is that the maximum current that one USB port is allowed to supply to a peripheral device is limited to some maximum level, typically 100 mA or 500 mA. Thus, the rate at which battery packs can be recharged, and the types of devices that can run from the power supplied by a USB host device are curtailed.

### BRIEF DESCRIPTION OF THE DRAWINGS

For a better understanding of the present invention and to show more clearly how it may be carried into effect, reference will now be made, by way of example, to the accompanying drawings, in which:

FIG. 1 shows a block diagram of a system for powering a peripheral device, in accordance with an embodiment of the invention;

FIG. 2 shows the control logic unit and the current adding unit of the system of FIG. 1; and

FIG. 3 shows a block diagram of another embodiment of a system for powering a peripheral device.

### DETAILED DESCRIPTION OF THE INVENTION

The present invention addresses the aforementioned drawback of limited available current from a USB port by exploiting the fact that a typical host device comes equipped with a plurality of USB ports. Thus, a system for powering a peripheral device with a host device is described below that includes N host interface power ports, where N is an integer greater than zero. Each host interface power port is adapted for coupling to a corresponding host port on the host device to deliver power to the peripheral device. The system for powering further includes a current adding unit for adding current received from the host device via at least the N host interface power ports to produce a total current. A power terminal in the device for powering is coupled to the peripheral device to send the total current from the current adding unit to the peripheral device. By drawing current from several ports instead of just one, the peripheral device is advantageously able to operate at higher amperages.

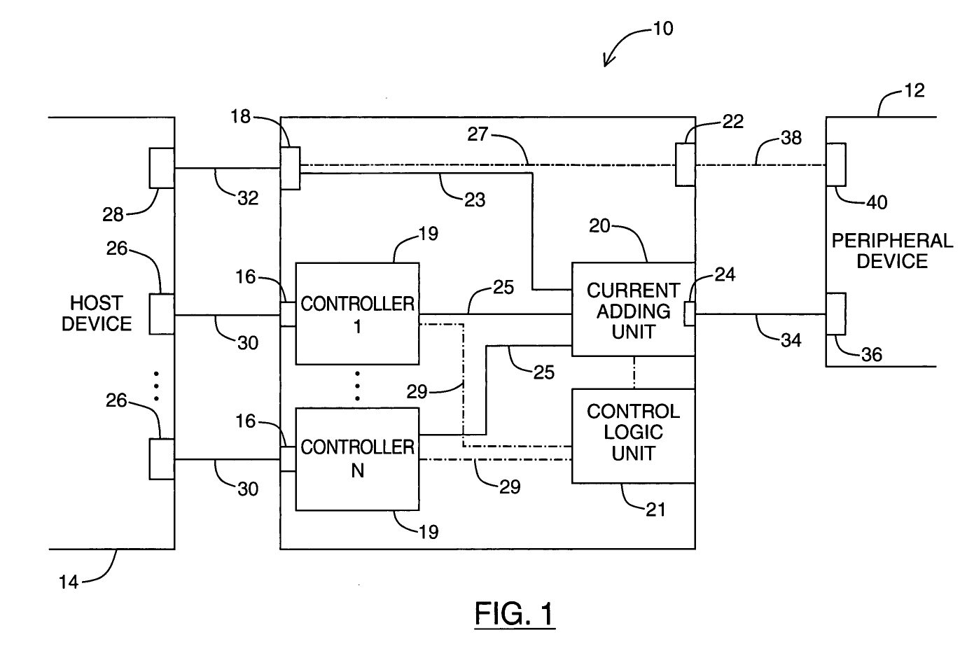

FIG. 1 shows a system 10 for powering a peripheral device 12 with a host device 14. The system 10 includes N host interface power ports 16, where N is any integer greater than zero, a host interface data port 18, N microcontrollers 19, a current adding unit 20, a control logic unit 21, a data terminal 22, a power connection 23, a power terminal 24 and N power connections 25, a data connection 27 and N data connections 29.

Each of the N host interface power ports 16 is coupled to a corresponding host port 26 on the host device 14 to deliver power to the peripheral device 12. For example, the N host power ports 26 can be universal serial bus (USB) ports that exchange data with and deliver power to the N host interface power ports 16 in conformity with the USB standard. The N host interface power ports 16 are coupled to the N host power ports 26 via cables 30. Power received by the N host interface power ports 16 from the host device 14 is delivered to the peripheral device 12, as described below.

The host interface data port 18 is coupled to a host data port 28 on the host device 14 to exchange data between the host device 14 and the peripheral device 12. In particular, data received by the host interface data port 18 is transmitted to the data terminal 22, and then to the peripheral device data port 40. In the embodiment shown, the host interface data port 18 can also receive current from the host data port 28 for powering the peripheral device 12. This current can be delivered to the current adding unit 20 by the power connection 23.

The host data port 28 can be similar to the N host power ports 26. For example, the host data port 28 can be a USB port that exchanges data with and delivers power to the host interface data port 18 in conformity with the USB standard. The host interface data port 18 can be coupled to the host data port 28 via a cable 32. Data and power received by the host interface data port 18 from the host device 14 is delivered to the peripheral device 12, as described below.

Each of the N host interface power ports 16 is coupled to a corresponding microcontroller 19. Each of the N microcontrollers 19 is enumerated by the host device 14 via the respective N host interface power ports 16. The enumeration allows the system 10 to draw current from each of the N host power ports 26 of the host device 14. In particular, as part of the enumeration process, the N microcontrollers 19 identify themselves to the host device 14 and negotiate the maximum current that can be drawn therefrom. The current received by the N microcontrollers 19 from the host device 14 is delivered to the current adding unit 20 via respective N connections 25.

The current adding unit 20 adds current received from the host device 14 via the N host interface power ports 16 and the N microcontrollers 19. In those embodiments in which the host interface data port 18 draws current from the host device 14, like the embodiment shown in FIG. 1, the current adding unit 20 also adds current received from the host interface data port 18 via a power connection 23 to produce a total current. Thus, the total current is the current produced by the current adding unit 20 by adding current received from the N host interface power ports 16 and the host interface data port 18.

The data terminal 22 of the system 10 is connected to the peripheral device 12 by a data cable 38. Data flows along a path that starts at the host data port 28, travels along the cable 32, crosses the host interface data port 18, travels along the data connection 27, crosses the data terminal 22, and travels along the data cable 38 to the peripheral device data port 40. In one embodiment, the power cable 34 and the data cable 38 are one in the same, and can deliver both power and data. In such case, the data terminal 22 and the power terminal 24 are coincident, as are the peripheral device power port 36 and the peripheral device data port 40.

The system 10 can also include a control logic unit 21 that is coupled to the N microcontrollers 19 for configuring the current adding unit 20 to produce a maximum total current that is available to the peripheral device. The available maximum total current depends on the maximum current that each of the N microcontrollers 19 negotiates with the host device 14. Thus, the control logic unit 21 uses enumeration information obtained by the N microcontrollers 19 from the host device 14 and delivered to the control logic unit 21 by the respective N data connections 29. This enumeration information is used by the control logic unit 21 to configure the current adding unit 20 for delivery of the maximum total current available to the peripheral device 12. This maximum total current dictates the speed at which the peripheral device 12 can be charged by the host device 14, for example. If the maximum total current available should change, as the N host interface power ports 16 are disconnected and reconnected, the control logic unit 21 reconfigures the current adding unit 20 accordingly. The maximum rate at which the host device 14 can charge the peripheral device 12 can correspondingly change.

In one embodiment, the total current that is delivered from the current adding unit 20 to the peripheral device 12 fluctuates as a function of time according to the demands of the peripheral device 12. The maximum total current is set by the control logic unit 21 according to what was negotiated between the N microcontrollers 19 and the host device 14 during the enumeration process, as described in more detail below.

The system 10 allows the total current delivered to the peripheral device 12 to be larger than could be delivered from the host interface data port 18 alone. For example, if each one of the N host interface power ports 16 and the host interface data port 18 is constrained by the USB standard to deliver a maximum of 500 mA of current, then the current adding unit 20 adds the individual currents to make available a maximum total current of (N+1)×500 mA to the peripheral device 12, instead of just 500 mA from the one host data port 28. To deliver this current to the peripheral device 12, the current adding unit 20 sends this maximum total current to the power terminal 24, which is coupled to the peripheral device 12 by a power cable 34. From the power terminal 24, the total current is delivered to the peripheral device 12 via the power cable 34 at a peripheral device power port 36.

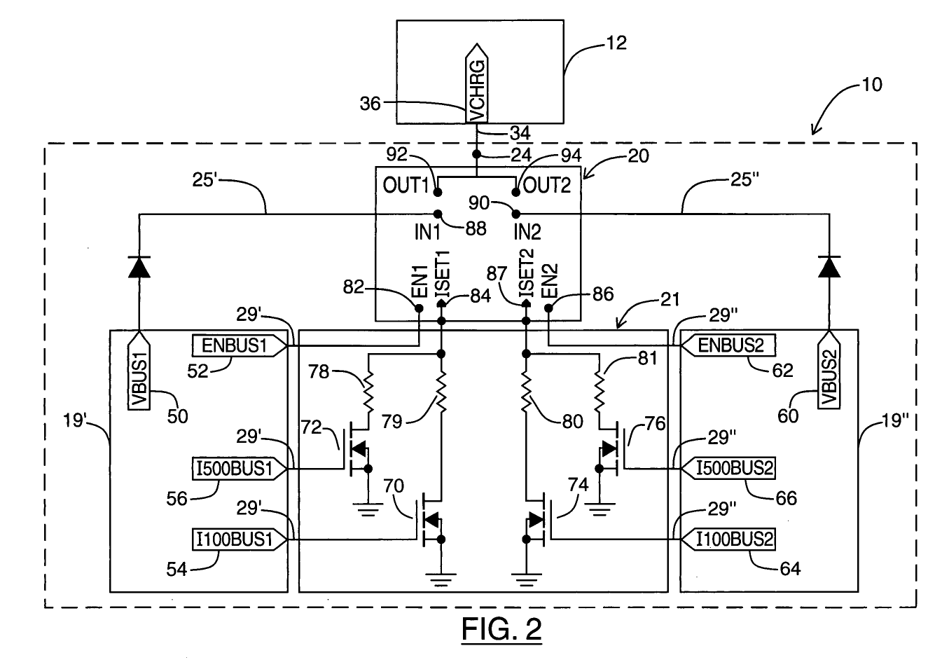

FIG. 2 shows the current adding unit 20 and the control logic unit 21 of the system 10 of FIG. 1. Also shown in FIG. 2 are N=2 microcontrollers 19′ and 19″. (In FIG. 1, all N microcontrollers are labeled by the reference 19, whereas in FIG. 2, the N=2 microcontrollers are distinguished by the use of primes 19′ and 19″, and similarly for the N data connections and the N power connections.). This number of microcontrollers is exemplary only, as N can be any integer greater than zero. The processor 19′ includes a VBUS1 terminal 50, an ENbus1 terminal 52, an I100bus1 terminal 54 and an I500bus1 terminal 56. Likewise, the processor 19″ includes a VBUS2 terminal 60, an ENbus2 terminal 62, an 100bus2 terminal 64 and an I500bus2 terminal 66.

The I100bus1 terminal 54 is coupled to a first FET 70 of the control logic unit 21, and the I500bus1 terminal 66 is coupled to a second FET 72 of the control logic unit 21. The I100bus2 terminal 64 is coupled to a third FET 74 of the control logic unit 21, and the I500bus2 terminal 66 is coupled to a fourth FET 76 of the control logic unit 21. The control logic unit 21 further includes four resistors 78-81.

The current adding unit 20 includes an EN1 terminal 82 coupled to the ENbus1 terminal 52, and an Iset1 terminal 84 coupled to the first and second FETs 70 and 72. The current adding unit 20 also includes an EN2 terminal 86 coupled to the ENbus2 terminal 62, and an Iset2 terminal 87 coupled to the third and fourth FETs 74 and 76. The current adding unit 20 further includes an in1 terminal 88 and an in2 terminal 90 respectively coupled to the VBUS1 terminal 50 and the VBUS2 terminal 60, via respective power connections 25′ and 25″. An out1 terminal 92 and an out2 terminal 94 of the current adding unit are coupled to the power terminal 24.

During enumeration, the microcontrollers 19′ and 19″ negotiate the maximum current that each can draw from the host device 14 via the N host power ports 26 and the N host interface power ports 16 to which they are coupled. If the N host power ports 26 are USB ports, then typically the host device 14 offers a choice of two maximum currents, 100 mA and 500 mA. If the microcontrollers 19′ and 19″ negotiate for a maximum current of 100 mA each, then respective voltages are asserted on the 1100bus1 terminal 54 and the 1100bus2 terminal 64 via the data connections 29′ and 29″, which close the gates on the first and third FETS 70 and 74. These steps result in a voltage being applied at the Iset1 terminal 84 and at the Iset2 terminal 87 that configure the current adding unit 20 for producing a maximum total current from the microcontrollers 19′ and 19″ of 200 mA.

If, instead, the microcontrollers 19′ and 19″ negotiate for a maximum current of 500 mA each, then respective voltages are asserted on the I500bus1 terminal 56 and the I500bus2 terminal 66, which close the gates on the second and fourth FETS 72 and 76. These steps result in a voltage being applied at the Iset1 terminal 84 and at the Iset2 terminal 87 that configure the current adding unit 20 for producing a maximum total current from the microcontrollers 19 and 19′ of 1000 mA.

The microcontroller 19′ asserts a voltage at the EN1 terminal 82, via the ENbus1 terminal 52 and the data connection 29′, to allow the current adding unit 20 to draw current from the microcontroller 19′ for the peripheral device 12. In particular, when the voltage is asserted at the EN1 terminal 82, a current pathway is established between the in1 terminal 88 and the out1 terminal 92 that permits current to flow from the host device 14 to the peripheral device 12. Likewise, the microcontroller 19″ asserts a voltage at the EN2 terminal 86, via the ENbus1 terminal 62 and the data connection 29″, to allow the current adding unit 20 to draw current from the microcontroller 19″ for the peripheral device 12. In particular, when the voltage is asserted at the EN2 terminal 86, a current pathway is established between the in1 terminal 90 and the out1 terminal 94 that permits current to flow from the host device 14 to the peripheral device 12.

When the EN1 terminal 82 and the EN2 terminal 86 are asserted, a maximum total current, whose value depends on the maximum currents negotiated by the microcontrollers 19′ and 19″ during enumeration, is available to the peripheral device 12. If the maximum amount of current is negotiated by the microcontrollers 19′ and 19″, under the conditions stated above, then the maximum total current available from the microcontrollers 19′ and 19″ is 1000 mA. In addition, the peripheral device 12 negotiates with the host device 14 the maximum current available from the host data port 28 (not shown if FIG. 2), which is coupled to the host interface data port 18 (not shown in FIG. 2) of the system 10. If the host data port 28 can provide a maximum current of 500 mA, then the total maximum current available to the peripheral device 12 from the host device 14 is 1500 mA. This can be favorably compared to only 500 mA if the peripheral device 12 could only draw current from the one host data port 28. It should be understood that 1500 mA is the maximum current that can be drawn by the peripheral device in this example. At any particular time, the current drawn by the peripheral device 12 from the host device 14 can be less than this maximum since USB permits the N host power ports 26 and the host data port 28 to supply current on demand up to some maximum current per port, which in this example is 500 mA.

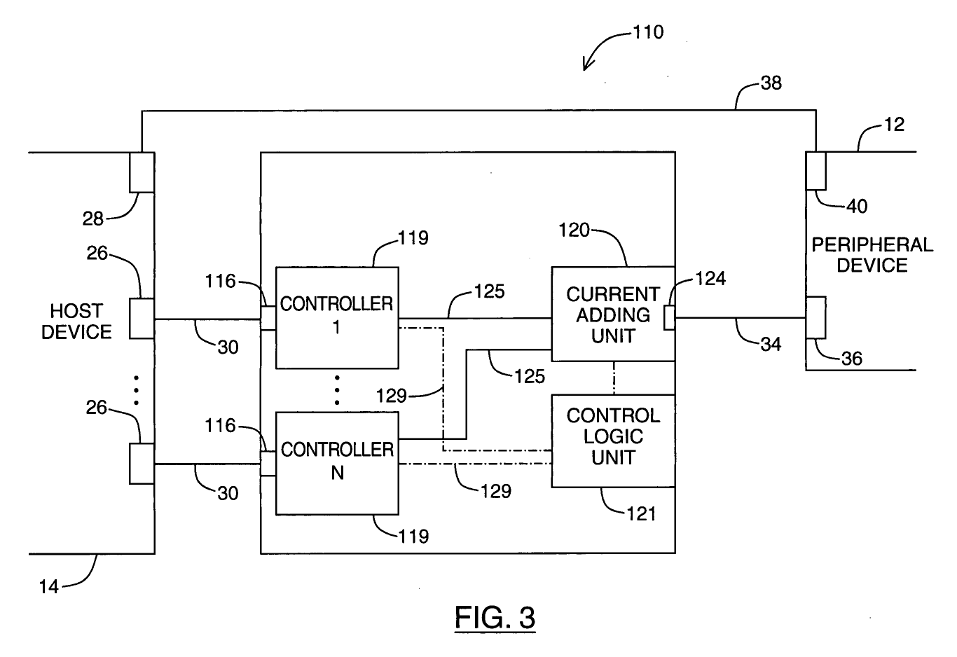

In FIG. 3, a different embodiment of a system 110 for powering a peripheral device 112 with a host device 114 is shown. The system 110 includes N host interface power ports 116, where N is any integer greater than zero, N microcontrollers 119, a current adding unit 120, a control logic unit 121, and a power terminal 124. Unlike the embodiment shown in FIG. 1, the host data port 28 of the host device 14 is directly connected to the peripheral device data port 40 with the data cable 38, instead of connected to the peripheral device data port 40 indirectly via the system 10. Thus, internal connections similar to 23 and 27 are not required. The host data port 28 can transfer data and power to the peripheral device 12, but, as mentioned above, in some implementations, the transfer of power can be reserved for the N host power ports 26.

Each of the N host interface power ports 116 is coupled to a corresponding host port 26 on the host device 14 to deliver power to the peripheral device 12. For example, the N host power ports 26 can be universal serial bus (USB) ports that exchange data with and deliver power to the N host interface power ports 116 in conformity with the USB standard. The N host interface power ports 116 are coupled to the N host power ports via cables 30. Power received by the N host interface power ports 116 from the host device 14 is delivered to the peripheral device 12.

The host data port 28 on the host device 14 is connected to a peripheral device data port 40 on the peripheral device 12 via the data cable 38 to allow data to be exchanged therebetween. The data cable 38 can also carry current from the host device 114 to the peripheral device 112 for powering the peripheral device 112, as mentioned above. The host data port 28 can be similar to the N host power ports 26. For example, the host data port 28 can be a USB port that exchanges data with the peripheral device data port 40 in conformity with the USB standard.

Each of the N host interface power ports 116 is coupled to a corresponding microcontroller 119. Each of the N microcontrollers 119 is enumerated by the host device 114 via the respective N host interface power ports 116. The enumeration allows the system 110 to draw current from each of the N host power ports 126 of the host device 114. In particular, as part of the enumeration process, the N microcontrollers 119 can negotiate the maximum amount of current that can be drawn from the respective N host power ports 26. The current received by the microcontrollers 119 from the host device 114 is delivered to the current adding unit 120 via N power connections 125.

The current adding unit 120 adds current received from the host device 114 via the N host interface power ports 116 and the N microcontrollers 119. The system 110 also includes a control logic unit 121 coupled to the N host interface power ports 116, via the N microcontrollers 119 and respective N data connections 129, to configure the current adding unit 120. The control logic unit 121 and the current adding unit 120 are similar to the control logic unit 21 and current adding unit 20, which were described in detail above.

Advantageously, the system 110 allows the maximum allowed current from each of the N host power ports 26 to be delivered to the peripheral device 112, in addition to whatever current from the one host data port 128 is available. The peripheral device 112 can thus be charged by the host device 114 at a faster rate. In addition, the host device 114 can power peripheral devices 112 requiring currents larger than can be supplied by just the one host data port 128.

It should be understood that various modifications could be made to the embodiments described and illustrated herein, without departing from the present invention, the scope of which is defined in the appended claims. For example, although emphasis has been placed on PDA's, other peripheral devices can benefit from the principles of the present invention.

1. A system for powering a peripheral device with a host device, the system comprising
N host interface power ports, where N is an integer greater than zero, each host interface power port adapted for coupling to a corresponding host port on the host device to deliver power to the peripheral device;
a current adding unit for adding current received from the host device via at least the N host interface power ports to produce a total current;
a power terminal adapted for coupling to the peripheral device to send the total current from the current adding unit to the peripheral device; and
N microcontrollers, each microcontroller being coupled to a corresponding one of the N host interface power ports, wherein the N microcontrollers are adapted to communicate with the host device for enumeration.

2. The system of claim 1, wherein the N microcontrollers are adapted for communication with the host device under a Universal Serial Bus (USB) standard.

3. The system of claim 1, further comprising a control logic unit coupled to the N microcontrollers and the current adding unit for configuring the current adding unit to produce a maximum total current that is available to the peripheral device based on the enumeration.

4. The system of claim 1, further comprising
a host interface data port adapted for coupling to a host data port on the host device to exchange data between the host device and the peripheral device; and
a data terminal adapted for coupling to the peripheral device to exchange data between the host device and the peripheral device via the host interface data port.

5. The system of claim 4, wherein the host interface data port is adapted for receiving current from the host device.

6. The system of claim 5, wherein the host interface data port is adapted to transfer current from the host device to the peripheral device via the power terminal.

7. The system of claim 6, further comprising N microcontrollers, each microcontroller being coupled to a corresponding one of the N host interface power ports, wherein the N microcontrollers are adapted to communicate with the host device for enumeration.

8. The system of claim 7, wherein the N microcontrollers are adapted for communication with the host device under a Universal Serial Bus (USB) standard.

9. The system of claim 7, further comprising a control logic unit coupled to the N microcontrollers for configuring the current adding unit to produce a maximum total current that is available to the peripheral device based on the enumeration.

10. A method for powering a peripheral device with a host device, the method comprising
providing an interface system having N host interface power ports, where N is an integer greater than zero, and a power terminal;
connecting each N host interface power ports to a corresponding host port on the host device to deliver power to the peripheral device;
the interface system adding current received from the host device via at least the N host interface power ports to produce a total current;
connecting the power terminal to the peripheral device to send the total current from the interface system to the peripheral device; and
coupling each of N microcontroller of the interface system to a corresponding one of the N host interface power ports for enumeration.

11. The method of claim 10, further comprising the host device enumerating the N microcontrollers via the N host interface power ports.

12. The method of claim 10, further comprising configuring a current adding unit of the interface system to produce a maximum total current that is available to the peripheral device.

13. The method of claim 12, further comprising the host device communicating with the N microcontrollers under a Universal Serial Bus standard.

14. The method of claim 10, wherein the interface system further includes a host interface data port and a data terminal, the method further comprising
connecting the host interface data port to a host data port on the host device to exchange data between the host device and the peripheral device; and
connecting the data terminal to the peripheral device to exchange data between the host device and the peripheral device via the host interface data port.

15. The method of claim 14, wherein the interface system includes N microcontrollers, the method further comprising coupling each microcontroller to a corresponding one of the N host interface power ports for enumeration.

16. The method of claim 15, further comprising the host device enumerating the N microcontrollers via the N host interface power ports.

17. The method of claim 16, further comprising configuring a current adding unit of the interface system to produce a maximum total current that is available to the peripheral device.

18. The method of claim 17, further comprising the host device communicating with the N microcontrollers under a Universal Serial Bus standard.
